(19) United States
(12) Patent Application Publication
(10) Pub. No.: US 2018/0022229 A1
(43) Pub. Date: Jan. 25, 2018

(54) SYSTEM AND METHOD FOR HEATING ELECTRIFIED VEHICLE BATTERY PACKS

(71) Applicant: FORD GLOBAL TECHNOLOGIES, LLC, Dearborn, MI (US)

(72) Inventors: Christian Johan Owen HANDLEY, Royal Oak, MI (US); Ken J. JACKSON, Dearborn, MI (US)

(21) Appl. No.: 15/215,957

(22) Filed: Jul. 21, 2016

(51) Int. Cl. B60L 11/18; B60W 10/06; B60W 20/00

(52) U.S. Cl. CPC B60L 11/1875; B60W 20/00; B60W 10/06; B60W 2510/246; B60W 2710/0644; Y10S 903/905

(57) ABSTRACT

A method includes controlling an electrified vehicle by modifying a power output of an engine to power an electric heating device for selectively heating a battery pack of the electrified vehicle.

### TECHNICAL FIELD

This disclosure relates to vehicle systems and methods for controlling electrified vehicles. An exemplary vehicle system is adapted to selectively modify a power output of an engine of the electrified vehicle. An excess power output of the engine is used to power an electric heating device during conditions in which it is beneficial to heat a battery pack of the electrified vehicle.

### BACKGROUND

The need to reduce automotive fuel consumption and emissions is well known. Therefore, vehicles are being developed that reduce reliance on internal combustion engines. Electrified vehicles are one type of vehicle currently being developed for this purpose. In general, electrified vehicles differ from conventional motor vehicles because they are selectively driven by one or more battery powered electric machines. Conventional motor vehicles, by contrast, rely exclusively on an internal combustion engine to drive the vehicle.

A high voltage battery pack typically powers the electric machines and other electrical loads of the electrified vehicle. The battery pack includes a plurality of battery cells that store energy for powering these loads. The battery cells must be periodically recharged to replenish their energy levels. The amount of energy that can be either added or extracted from the battery cells can be limited during cold ambient conditions.

### SUMMARY

A method according to an exemplary aspect of the present disclosure includes, among other things, controlling an electrified vehicle by modifying a power output of an engine to power an electric heating device for selectively heating a battery pack of the electrified vehicle.

A further non-limiting embodiment of the foregoing method includes modifying at least one of a speed output and a torque output of a crankshaft of the engine.

A further non-limiting embodiment of any of the foregoing methods includes modifying the power output of the engine to power the electric heating device if a temperature of the battery pack is less than a target temperature and a power limit of the battery pack is less than a target power limit.

A further non-limiting embodiment of any of the foregoing methods includes modifying the power output of the engine to power the electric heating device if an engine coolant temperature is less than a target engine coolant temperature.

A further non-limiting embodiment of any of the foregoing methods includes the modifying the power output of the engine to power the electric heating device if a brake specific fuel consumption of the engine is different from a target brake specific fuel consumption.

A further non-limiting embodiment of any of the foregoing methods includes modifying the power output of the engine to power the electric heating device if an engine coolant temperature is less than a target engine coolant temperature, an engine operating point is different from an engine operating point target, a temperature of the battery pack is less than a target temperature, or a power limit of the battery pack is less than a target power limit.

A further non-limiting embodiment of any of the foregoing methods includes continuing to power the electric heating device until a power limit of the battery pack is equal to or within range of a target power limit.

A further non-limiting embodiment of any of the foregoing methods includes lowering the power output of the engine and deactivating the electric heating device if the power limit of the battery pack is equal to or within range of the target power limit.

A further non-limiting embodiment of any of the foregoing methods includes shutting down the engine if an engine coolant temperature exceeds a target engine coolant temperature.

A further non-limiting embodiment of any of the foregoing methods includes controlling the engine using normal engine logic if an engine coolant temperature is less than a target engine coolant temperature.

A further non-limiting embodiment of any of the foregoing methods includes shutting down the engine if an engine coolant temperature exceeds a target engine coolant temperature.

A further non-limiting embodiment of any of the foregoing methods includes heating a medium with the electric heating device and using the medium to heat battery cells of the battery pack.

A further non-limiting embodiment of any of the foregoing methods includes utilizing excess regen power to selectively augment powering the electric heating device.

An electrified vehicle according to another exemplary aspect of the present disclosure includes, among other things, an engine, a battery pack, an electric heating device configured to heat the battery pack, and a control system configured with instructions for selectively modifying a power output of the engine to meet a load of the electric heating device.

In a further non-limiting embodiment of the foregoing electrified vehicle, the electric heating device includes a resistive heating device.

In a further non-limiting embodiment of the foregoing electrified vehicle, the electric heating device includes a positive temperature coefficient heater.

In a further non-limiting embodiment of the foregoing electrified vehicle, the electric heating device includes an infrared heating device.

In a further non-limiting embodiment of the foregoing electrified vehicle, the electric heating device is part of a liquid or air thermal management system.

In a further non-limiting embodiment of the foregoing electrified vehicle, the control system is configured to communicate a power output request signal to the engine. The power output request signal includes instructions for increasing a revolutions per minute (RPM) output or torque output of a crankshaft of the engine.

A further non-limiting embodiment of the foregoing electrified vehicle includes a step-down converter configured to reduce an input voltage received from the engine to a lower voltage sufficient for powering the electric heating device.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a vehicle system of an electrified vehicle.

FIG. 3 illustrates an exemplary battery thermal management circuit.

FIG. 4 illustrates another exemplary battery thermal management circuit.

FIG. 5 schematically illustrates an exemplary control strategy for controlling an electrified vehicle during conditions in which it is beneficial to heat a battery pack.

### DETAILED DESCRIPTION

This disclosure details a system and method for controlling an electrified vehicle in a manner that improves its performance. A power output of an engine of the electrified vehicle may be selectively modified for generating power to meet an electric heating device load during conditions in which it is beneficial to heat the battery pack. In some embodiments, the battery pack is heated by the electric heating device during cold ambient conditions. The engine is reverted back to normal engine logic (engine off, lower power output, etc.) once the power limits of the battery pack are within a desired range. These and other features are discussed in greater detail in the following paragraphs of this detailed description.

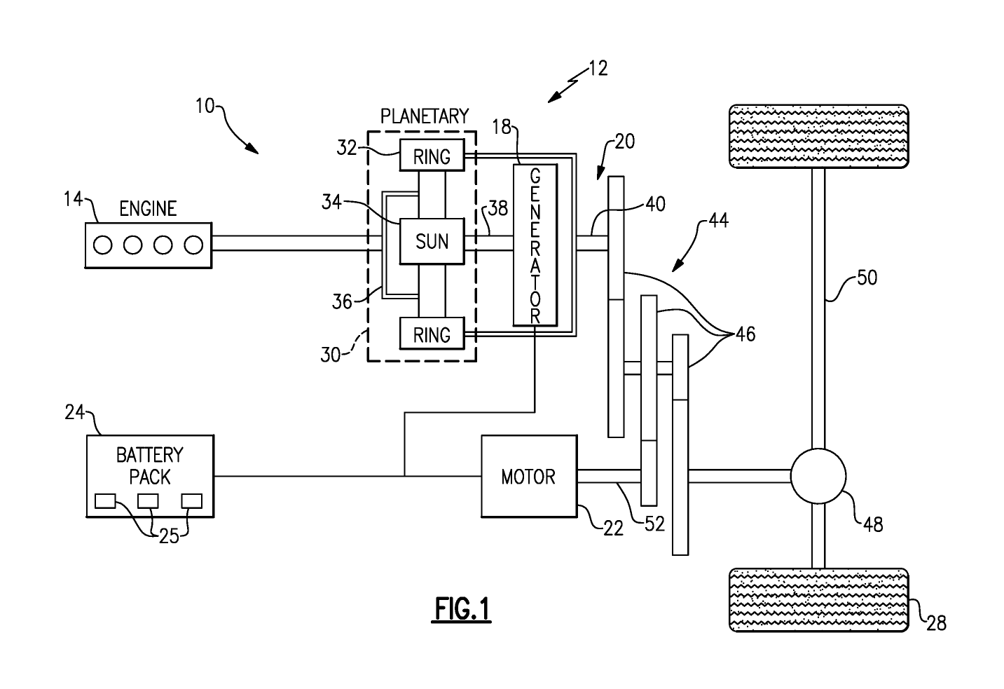

FIG. 1 schematically illustrates a powertrain 10 of an electrified vehicle 12. Although depicted as a hybrid electric vehicle (HEV), it should be understood that the concepts described herein are not limited to HEV's and could extend to other electrified vehicles, including, but not limited to, plug-in hybrid electric vehicles (PHEV's).

In a non-limiting embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is depicted in FIG. 1, other powertrain configurations could also benefit from the teachings of this disclosure.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22 and/or other electrical loads of the electrified vehicle 12. Other types of energy storage devices and/or output devices could also be used to electrically power the electrified vehicle 12.

In another non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

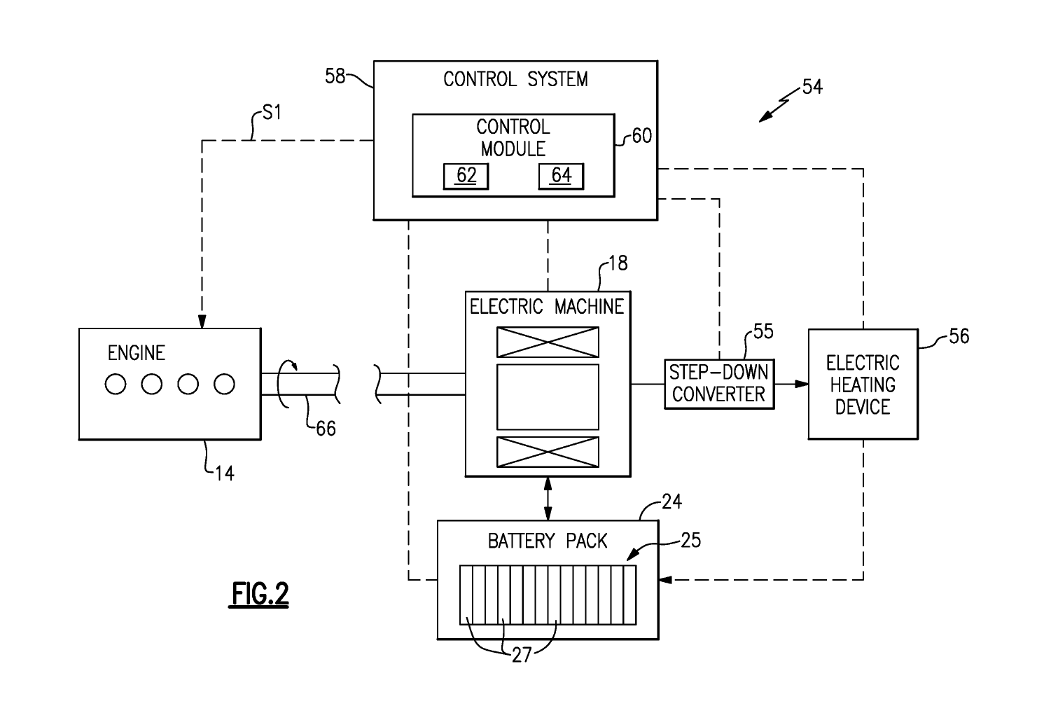

FIG. 2 is a highly schematic depiction of a vehicle system 54 for an electrified vehicle. For example, the vehicle system 54 could be incorporated for use within the electrified vehicle 12 of FIG. 1, or any other electrified vehicle. The vehicle system 54 is adapted to modify a power output of the engine 14 of the electrified vehicle 12 in order to power an electric heating device 56 during conditions in which it is beneficial to heat the battery pack 24.

In a non-limiting embodiment, the vehicle system 54 includes an engine 14, an electric machine 18, a battery pack 24, an electric heating device 56, and a control system 58. The vehicle system 54 may optionally include a step-down converter 55. These components and their respective functions are each discussed below.

The engine 14 may be an internal combustion engine. The engine 14 could alternatively be any other type of power source capable of generating electricity for powering the electric machine 18, the electric heating device 56, and other loads.

The electric machine 18 may be a motor or a generator. In a non-limiting embodiment, the electric machine 18 functions as a combined motor/generator. In another non-limiting embodiment, the electric machine 18 is a permanent magnet synchronous motor.

The battery pack 24 includes one or more battery assemblies 25, or groupings of battery cells 27. Each battery assembly 25 includes a plurality of the battery cells 27, or any other type of energy storage device. The battery cells 27 store electrical energy that may be selectively supplied to power various electrical loads of the electrified vehicle 12. These electrical loads include various high voltage loads (e.g., electric machines, etc.), or various low voltage loads (e.g., lighting systems, low voltage batteries, logic circuitry, etc.).

The electric heating device 56 may be positioned in proximity to the battery pack 24 for selectively heating the battery pack 24 during cold ambient conditions or other conditions. For example, the electric heating device 56 could be employed to heat a medium (e.g., a fluid or air) that is then directed to the battery pack 24 for heating the battery cells 27. In a non-limiting embodiment, the electric heating device 56 is a positive temperature coefficient (PTC) heater. In another non-limiting embodiment, the electric heating device 56 is an infrared heating device. In yet another non-limiting embodiment, the electric heating device 56 is a resistive heating device. The electric heating device 56 may be selected such that its maximum regulating temperature is within the optimal operating temperature range of the battery pack 24. Although a single electric heating device 56 is shown, the vehicle system 54 could employ multiple electric heating devices 56 for heating the battery pack 24.

The electric heating device 56 could be either a high voltage device or a low voltage device. In embodiments in which the vehicle system 54 utilizes a low voltage electric heating device 56, the step-down converter 55 may be employed to reduce the input voltage received from the engine 14 or the electric machine 18 to a lower voltage sufficient for powering the electric heating device 56. In a non-limiting embodiment, the step-down converter 55 is a DC-to-DC power converter. The step-down converter 55 may not be necessary in some embodiments, such as when the vehicle system 54 utilizes a high voltage electric heating device 56.

The electric heating device 56 can be powered using electricity generated by the engine 14. For example, a power output of the engine 14 may be modified to selectively power the electric heating device 56. In a non-limiting embodiment, the power output of the engine 14 is modified by increasing an output, measured in revolutions per minute (RPM's), of a crankshaft 66 of the engine 14.

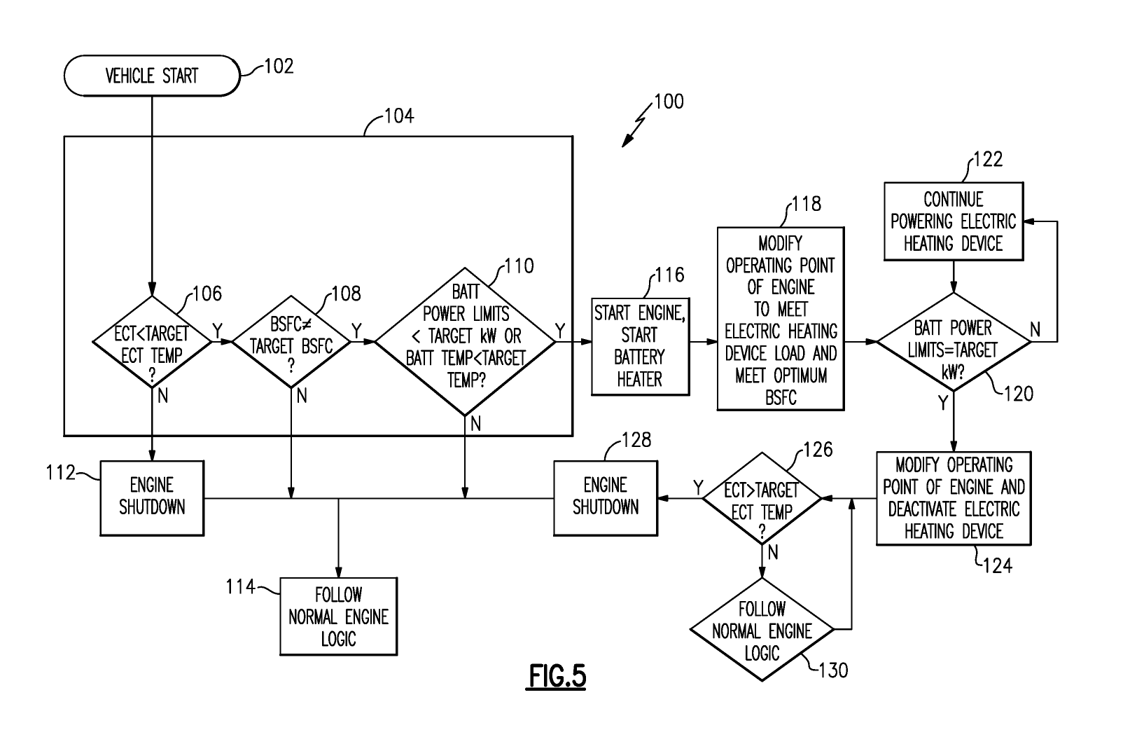

The control system 58 could be part of an overall vehicle system controller (VSE) or could be a separate control system that communicates with the VSC. The control system 58 includes one or more control module 60 equipped with executable instructions for interfacing with and commanding operation of various components of the vehicle system 54. For example, in a non-limiting embodiment, each of the engine 14, the electric machine 18, and the battery pack 24 includes a control module, and these control modules can communicate with one another over a controller area network (CAN) to control the electrified vehicle 12. In another non-limiting embodiment, each control module 60 of the control system 58 includes a processing unit 62 and non-transitory memory 64 for executing the various control strategies and modes of the vehicle system 54. One exemplary control strategy of the vehicle system 54 is discussed below with reference to FIG. 5.

An exemplary function of the control system 58 is to monitor various parameters associated with the engine 14 and the battery pack 24. By way of non-limiting examples, the control system 58 may monitor coolant temperatures and brake specific fuel consumption (BSFC) of the engine 14 and power limits and temperatures of the battery pack 24. These parameters may be collected and analyzed by the control system 58 to determine whether or not it is beneficial to heat the battery pack 24, as discussed in greater detail below.

Another exemplary function of the control system 58 is to control operation of the engine 14 for generating power to meet an electric load of the electric heating device 56. For example, the control system 58 may periodically communicate a power output request signal S1 to the engine 14. The power output request signal S1 commands the engine to produce a specific power output, or a specific RPM output of the crankshaft 66. In a non-limiting embodiment, the power output of the engine 14 is controlled to generate a greater amount of power than is necessary to propel the electrified vehicle 12. This additional energy can be used to power the electric heating device 56. In a non-limiting embodiment, the additional power generated by the engine 14 is consumed by the electric machine 18, which is being operated as a generator, and is then provided to the electric heating device 56 if the control system 58 has determined that it is desirable to heat the battery pack 24.

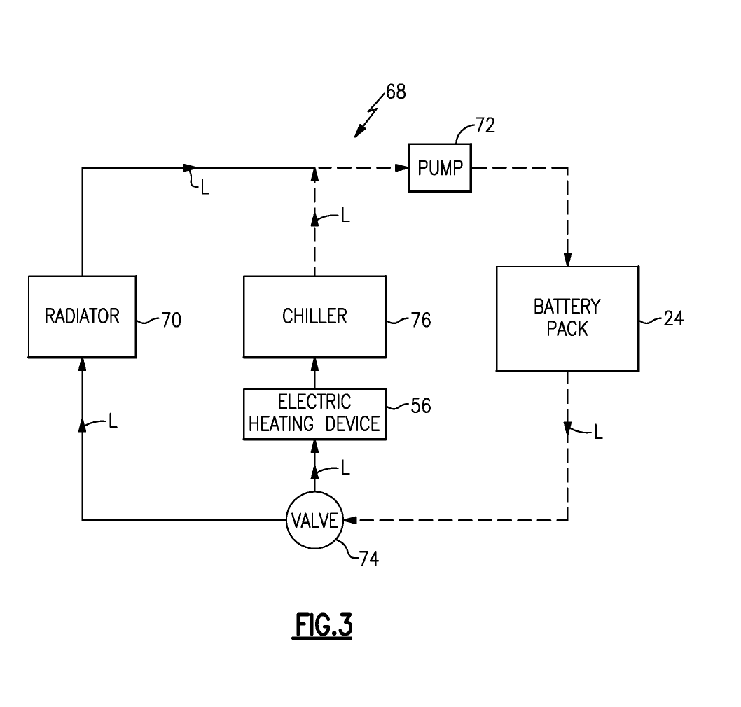

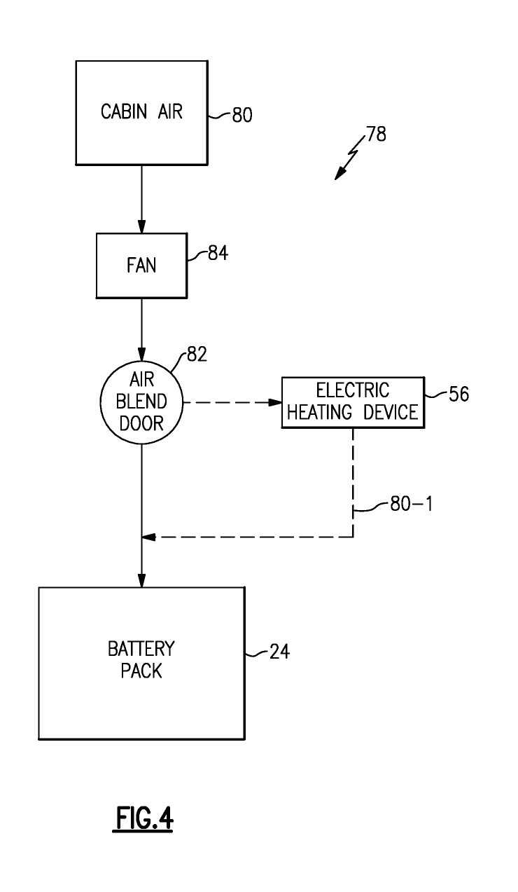

The electric heating device 56 may be part of a battery pack thermal management circuit. Various types of thermal management circuits are contemplated within the scope of this disclosure. Two non-limiting examples of suitable thermal management circuits are illustrated in FIGS. 3 and 4.

Referring first to FIG. 3, the electric heating device 56 is part of a liquid thermal management circuit 68. The liquid thermal management circuit 68 selectively communicates a liquid L, such as water or glycol, to the battery pack 24 to thermally manage the battery cells of the battery pack 24. The liquid L can be circulated through an internal circuit of the battery pack 24 or in some other manner to either add heat to or remove heat from the battery cells.

In a non-limiting embodiment, the liquid thermal management circuit 68 includes a radiator 70, a pump 72, a valve 74, the electric heating device 56, and a chiller 76. The liquid thermal management circuit 68 may be operated in either a cooling mode to cool the battery pack 24 or a heating mode to heat the battery pack 24. For example, during cooling mode, the pump 72 communicates the liquid L through the radiator 70. Heat from the liquid L is rejected to atmosphere within the radiator 70. The cooled liquid L exiting the radiator 70 is then returned to the battery pack 24 for cooling the battery cells 27. A portion of the liquid L may also be communicated through the chiller 76 to augment the cooling provided by the radiator 70. The valve 74 is adapted to control the flow of the liquid L to the radiator 70, the chiller 76, or both.

Alternatively, during heating mode, the valve 74 directs the liquid L exiting the battery pack 24 to the electric heating device 56. The electric heating device 56 is actuated to heat the liquid L. The heated liquid L is then communicated to the battery pack 24 for heating the battery cells 27. The chiller 76 is typically inactive during the heating mode.

An air thermal management circuit 78 is schematically illustrated in FIG. 4. Cabin air 80 extracted from an interior cabin of the electrified vehicle is directed to an air blend door 82 by a fan 84. The fan 84 could be upstream or downstream of the battery pack 24. During cooling mode, the air blend door 82 directs the cabin air 80 to the battery pack 24 for cooling the battery cells. Alternatively, during heating mode, the air blend door 82 may direct all or a portion of the cabin air 80 to the electric heating device 56 for heating the cabin air 80. Heated air 80-1 is then directed to the battery pack 24 for heating the battery cells.

In yet another non-limiting embodiment, the air blend door 82 is optional. In such an embodiment, the cabin air 80 is communicated directly to the electric heating device 56.

FIG. 5, with continued reference to FIGS. 1-4, schematically illustrates a control strategy 100 for controlling an electrified vehicle 12. For example, the control strategy 100 can be performed to control operation of the electrified vehicle 12 by heating the battery pack 24 during conditions in which it is beneficial to do so. In one non-limiting embodiment, the control system 58 is programmed with one or more algorithms adapted to execute the exemplary control strategy 100, or any other control strategy. In another non-limiting embodiment, the control strategy 100 is stored as executable instructions in the non-transitory memory 64 of the control module 60 of the control system 58.

The control strategy 100 begins at block 102 at a vehicle start. The control strategy 100 may then begin an algorithm 104 for determining whether or not it is beneficial to heat the battery pack 24. The exemplary algorithm 104 is shown as including blocks 106, 108, and 110. However, in another non-limiting embodiment, the algorithm 104 could include one or more of blocks 106, 108, and 110.

First, at block 106 of the algorithm 104, an engine coolant temperature (ECT) associated with the engine 14 is compared to a target engine coolant temperature (ECT). The target engine coolant temperature (ECT) is a predetermined value or range stored in the non-transitory memory 64 of the control module 60 and can vary depending on the configuration of the engine 14 and the electrified vehicle 12, among other criteria. If the engine coolant temperature (ECT) exceeds the target engine coolant temperature (ECT), the engine 14 is shutdown at block 112, thus indicating that it is not beneficial to heat the battery pack 24 at that time. The control strategy 100 may proceed to block 108 if the engine coolant temperature (ECT) is less than the target engine coolant temperature (ECT).

A brake specific fuel consumption (BSFC) of the engine 14 is compared to a target brake specific fuel consumption (BSFC) at block 108. The target brake specific fuel consumption (BSFC) is a predetermined value or range that is a measure of the relative fuel efficiency of the engine 14. This value or range is also design dependent and can depend on the configuration of the engine 14 and the electric machine 18, among other criteria. If the brake specific fuel consumption (BSFC) is within the predefined range of the target brake specific fuel consumption (BSFC), the engine 14 is controlled using normal engine logic at block 114. The control strategy 100 may proceed to block 110 if the measured brake specific fuel consumption (BSFC) is different from the target brake specific fuel consumption (BSFC).

Various operating conditions of the battery pack 24 may be analyzed and compared to target or threshold values at block 110. In a non-limiting embodiment, the power limits (i.e., the amount of energy that can be added to or extracted from the battery pack 24 at any given time, measured in kW) and the temperature of the battery pack 24 are compared to target values at block 110. If either the current power limits or the current temperature of the battery pack 24 exceeds the target power limit value or the target temperature value, respectively, the engine 14 is controlled using normal engine logic at block 114. Alternatively, the control strategy 100 may proceed to block 116 if the battery pack power limits are less than a target battery pack power limit and the battery pack temperature is less than a target battery pack temperature. The target battery pack power limit and the target battery pack temperature are design dependent, predefined values or ranges. In a non-limiting embodiment, the target battery pack temperature is approximately 20° C. (68° F.).

If it is ultimately determined that it would be beneficial to heat the battery pack 24 after executing the algorithm 104, the control strategy 100 may proceed to block 116. At this block, the engine 14 is started to begin powering the electric heating device 56, and thus begin heating the battery pack 24. A power output operating point (i.e., RPM output or torque of crankshaft 66) of the engine 14 can be modified (e.g., increased) at block 118 to meet the load of the electric heating device 56 and to run the engine 14 at a target brake specific fuel consumption (BSFC).

The battery pack power limits are again compared to the target battery pack power limits at block 120. The electric heating device 56 is continuously powered by the engine 14 until the power limits of the battery pack 24 are equal to or within an acceptable target of the target battery pack power limits (see block 122). In a non-limiting embodiment, excess regen power captured during regenerative braking events may be selectively used during block 122 to augment powering of the electric heating device 56. In other words, the engine 14 and excess regen power may both be used to power the electric heating device 56.

Once the battery pack power limits are within a desirable range, the control strategy 100 may proceed to block 124. At this block, the power output operating point of the engine 14 is lowered the electric heating device 56 is deactivated so the battery pack 24 is no longer being heated.

The engine coolant temperature (ECT) is again compared to the target engine coolant temperature (ECT) at block 126. The engine 14 is shutdown at block 128 if the engine coolant temperature (ECT) exceeds the target engine coolant temperature (ECT). Alternatively, if the engine coolant temperature (ECT) is less than the target engine coolant temperature (ECT), the engine 14 can be operated using normal engine logic at block 130.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method, comprising:
controlling an electrified vehicle by modifying a power output of an engine to power an electric heating device for selectively heating a battery pack of the electrified vehicle.

2. The method as recited in claim 1, wherein modifying the power output of the engine includes modifying at least one of a speed output and a torque output of a crankshaft of the engine.

3. The method as recited in claim 1, wherein the power output of the engine is modified to power the electric heating device if a temperature of the battery pack is less than a target temperature and a power limit of the battery pack is less than a target power limit.

4. The method as recited in claim 1, wherein the power output of the engine is modified to power the electric heating device if an engine coolant temperature is less than a target engine coolant temperature.

5. The method as recited in claim 1, wherein the power output of the engine is modified to power the electric heating device if a brake specific fuel consumption of the engine is different from a target brake specific fuel consumption.

6. The method as recited in claim 1, wherein the power output of the engine is modified to power the electric heating device if:
an engine coolant temperature is less than a target engine coolant temperature;
an engine operating point is different from an engine operating point target;
a temperature of the battery pack is less than a target temperature; or
a power limit of the battery pack is less than a target power limit.

7. The method as recited in claim 1, comprising continuing to power the electric heating device until a power limit of the battery pack is equal to or within range of a target power limit.

8. The method as recited in claim 7, comprising lowering the power output of the engine and deactivating the electric heating device if the power limit of the battery pack is equal to or within range of the target power limit.

9. The method as recited in claim 8, comprising shutting down the engine if an engine coolant temperature exceeds a target engine coolant temperature.

10. The method as recited in claim 8, comprising controlling the engine using normal engine logic if an engine coolant temperature is less than a target engine coolant temperature.

11. The method as recited in claim 1, comprising shutting down the engine if an engine coolant temperature exceeds a target engine coolant temperature.

12. The method as recited in claim 1, comprising:
heating a medium with the electric heating device; and
using the medium to heat battery cells of the battery pack.

13. The method as recited in claim 1, comprising utilizing excess regen power to selectively augment powering the electric heating device.

14. An electrified vehicle, comprising:
an engine;
a battery pack;
an electric heating device configured to heat said battery pack; and
a control system configured with instructions for selectively modifying a power output of said engine to meet a load of said electric heating device.

15. The electrified vehicle as recited in claim 14, wherein said electric heating device includes a resistive heating device.

16. The electrified vehicle as recited in claim 14, wherein said electric heating device includes a positive temperature coefficient (PTC) heater.

17. The electrified vehicle as recited in claim 14, wherein said electric heating device includes an infrared heating device.

18. The electrified vehicle as recited in claim 14, wherein said electric heating device is part of a liquid or air thermal management circuit.

19. The electrified vehicle as recited in claim 14, wherein said control system is configured to communicate a power output request signal to said engine, said power output request signal including instructions for increasing a revolutions per minute (RPM) output or torque output of a crankshaft of said engine.

20. The electrified vehicle as recited in claim 14, comprising a step-down converter configured to reduce an input voltage received from said engine to a lower voltage sufficient for powering said electric heating device.
